(19) United States
(12) Patent Application Publication
(10) Pub. No.: US 2007/0041558 A1
(43) Pub. Date: Feb. 22, 2007

(54) Subscriber status determination and call content interception

(76) Inventors: Shiby Sugunan Parayil, Longmont, CO (US); Marcus D'Wayne Cooksey, McKinney, TX (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/434,690

(22) Filed: May 16, 2006

Related U.S. Application Data
(60) Provisional application No. 60/681,608, filed on May 17, 2005.

(51) Int. Cl. H04M 7/00; H04L 12/66

(52) U.S. Cl. 379/219; 370/352

(57) ABSTRACT

Call content may be intercepted for law enforcement purposes by detecting subscriber status and then routing the relevant media streams to a conferencing means such as a conference bridge or a media server. The target subscriber and others in conversation with the target may be provisioned on the same switch as the monitoring agency seeking to intercept the call content or may be distributed over multiple, discrete networks and switches.

### CROSS-REFERENCE TO RELATED APPLICATIONS

This application is related to and claims the benefit of commonly-owned U.S. Provisional Application no. 60/681,608, filed May 17, 2005 and titled “Seamless Verifiability of Subscribers on a Next Generation Network,” incorporated by reference herein. It is also related to U.S. Application Ser. No. 10/356,299, filed Nov. 27, 2003 and titled “Call-Content Determinative Selection of Interception Access Points, in a Soft Switch Controlled Network,” incorporated by reference herein.

### BACKGROUND OF THE INVENTION

The invention described and claimed here concerns law enforcement monitoring of telephone conversations under the Communications Assistance for Law Enforcement Act of 1994 (CALEA), 47 U.S.C. §§1001-1010, mandating that telecommunications carriers provide law enforcement agencies with access to the telecommunications networks to enable lawfully-ordered intercept of the voice content of telecommunications.

### BRIEF DESCRIPTION OF THE DRAWINGS

FIG. 1 is a block diagram of a telecommunications system incorporating a softswitch and the logical connections for call interception;

FIG. 2 is a call flow diagram of a subscriber status determination process; and

FIG. 3 is a call flow diagram of a call interception process.

### DESCRIPTION OF THE INVENTION

The interception of a telephone may be accomplished in two steps: (1) determination of the status of a target subscriber; and (2) call interception. The latter enables an authorized law enforcement representative to monitor the call.

Architecture

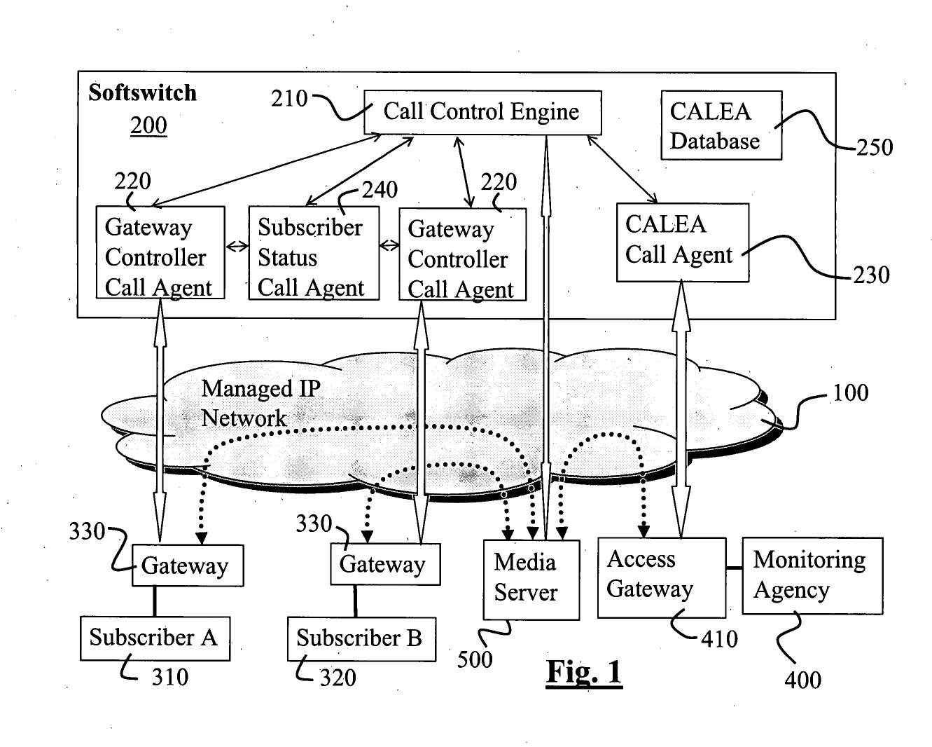

A telecommunications system, shown in FIG. 1, illustrates the components relevant to this discussion. An IP network 100,,depicted as a cloud, is managed in part by a softswitch 200. The softswitch 200 contains a call control engine 210, gateway controller call agents 220, a CALEA call agent 230, a subscriber status call agent 240, and a CALEA database 250.

The call control engine 210 is responsible for setting up and tearing down connections generally and, in this context, it also oversees the determination of subscriber status and interception of call content. While the gateway controller call agents 220 carry out the call setup and tear down functions, the subscriber status call agent 240 described here is tasked solely with determining the status of a subscriber, although it too could have other functions and capabilities. For this purpose, the subscriber status call agent 240 may have a database containing subscriber status information or it may relay on a database located elsewhere in the softswitch 200 or the network.

The system shown in FIG. 1 also illustrates subscribers identified as “Subscriber A” 310 and “Subscriber B” 320, which access the IP network 100 through respective gateways 330. These gateways 330 may interact with the gateway controller call agents 220 in a peer-to-peer or a master-slave relationship.

“Subscriber A” is the target—the party of interest, whose telephone conversations the law enforcement agency or “monitoring agency” 400 wishes to intercept. The subscribers may be conventional landline telephones (PSTN), cellular telephones, VoIP devices, or any other devices that can access the network 100, utilizing any desired compatible protocol (e.g., H.323, MGCP, SIP, etc.). Although individual access gateways 330 are provided in FIG. 1 for Subscribers A and B, if appropriate, these two subscribers could access the network 100 through the same gateway.

In the arrangement shown in FIG. 1, both subscribers (A and B) are controlled by the same switch, implying that they are both provisioned (i.e., registered) on this switch. However, one or both of the subscribers may be located in remote networks, e.g., the networks of other service providers, or under the control of other switches. In such a case, the procedures described here will involve the active participation of those remote networks and switches.

An access gateway 410 provides the monitoring agency 400 with access to the softswitch 200 through the network 100 and specifically the CALEA call agent 230. The monitoring agency 400 may access the switch 200 utilizing any desired protocol or device (e.g., H.323, MGCP, SIP, etc.; landline, cellular telephone, VoIP device, etc.) through a protocol-appropriate gateway.

Subscriber Status Determination

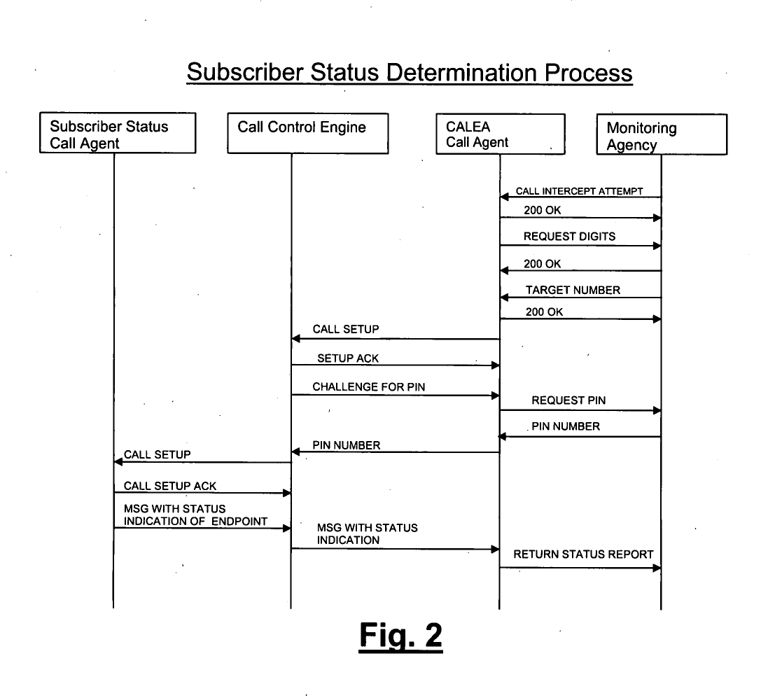

Before setting up the connections necessary to intercept call content, the system first determines the status of Subscriber A, the target subscriber. A signaling scheme for making this determination is set forth in the call flow diagram of FIG. 2. In the examples discussed here, there are four possible states for a subscriber—idle, off-hook, call-processing busy (call in progress), and status restricted, although there could be more or fewer such states as dictated by design considerations. The last indicated state, “status restricted,” may result when the queried party may not for whatever reason (e.g., legal) or cannot be monitored (e.g., for technical reasons).

The monitoring agency 400 sends a request for call interception to the CALEA call agent 230. The CALEA call agent 230 in turn requests the number of the target subscriber (Subscriber A) from the monitoring agency 400, if the number has not already been provided with the initial request. The CALEA call agent 230 then sends a request to the call control engine 210, requesting set up of a status-determination call to Subscriber A to determine subscriber status.

In the configuration shown here, the call control engine 210 determines whether the monitoring agency 400 is authorized to make this request, challenging the agency 400 for a PIN. This function could have been handled by the CALEA call agent 230 or some other network or switch component. Further, it could occur at a different stage of the procedure. Authorizing information, which may include the telephone numbers of target subscribers and law enforcement identifying information, may be stored in a database such as the exemplary CALEA database 250. This database 250 may reside in the softswitch 200 or it may be located elsewhere, as desired. Further, the authorization may be blanket or subscriber-specific. In the example of FIG. 2, the monitoring agency 400 supplies a PIN.

Once the authorization clears, the call control engine 210 sets up the status-determination call through the subscriber status call agent 240, which would query the gateway controller call agent 220 provisioned to the target, Subscriber A. The gateway controller call agent 220 for Subscriber A either has or obtains the information sought by the subscriber status call agent 240, including its current state and existing connections. The subscriber status call agent 240 returns a status message to the call control engine 210, which is then passed to the CALEA call agent 230. The call flow diagram of FIG. 2 provides that status is indicated by an audible tone, but the status message could assume another form such as data appearing in a display or a pre-recorded verbal announcement. In the case of a remote monitored party, i.e., a subscriber provisioned on another switch or in an entirely different network, the remote switch or network would provide status information to the softswitch 200.

Call Interception

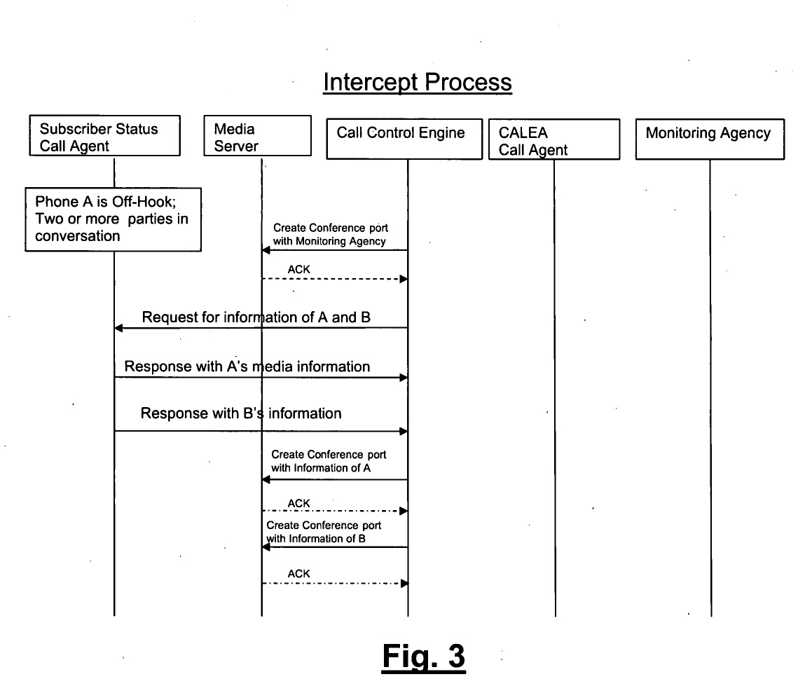

If the target is in conversation with another party (or parties), the call can be intercepted. A suggested signaling procedure for accomplishing call interception is shown in the call flow diagram of FIG. 3. A media server 500 (FIG. 1), functioning as a conference bridge, provides a means for acquiring access to the call content (i.e., the call). To intercept call content, the media streams of the monitored parties (the subscriber media streams) are re-routed or translated to ports on the media server 500.

The call control engine 210 first requests that the media server 500 create a port for the monitoring agency 400. A dotted line in the IP network cloud 100 connecting the media server 500 and the access gateway 410 represents the media stream carrying the intercepted call back to the monitoring agency 400.

The call control engine 210 then queries the subscriber status call agent 240, seeking media information about the target Subscriber A and all other participating target subscribers, i.e., Subscriber B, etc. The media information provides the call control engine 210 with the details of the call and the identities of the parties to the call.

The call control engine 210 then sets up the conference, creating ports on the media server 500 for Subscriber A, Subscriber B, and any others. The respective media streams for each of these subscribers are then rerouted (or translated) to the ports on the media server 500, as depicted by the dotted lines in the IP network cloud 100 connecting the gateways 330 to the media server 500 (the ports being simply illustrated by arrow heads). If desired, the port for the monitoring agency 400 could be established after the media streams of the target and the other subscribers have been re-routed to the media server 500. Once all of the target subscribers return to an idle state, the conference can be torn down.

The status determination and intercept processes can be utilized in a variety of networks. Architectures suitable for such an application include the Siemens SURPASS hiQ8000 softswitch, described in “SURPASS hiQ8000—The Winning Softswitch Strategy for NGN Solutions,” Ref. No. A50001-N2-P121-1-7600, dated 2003, and the systems described in the MultiService Forum Technical Report, “Bandwidth Management in Next Generation Packet Networks,” MSF-TR-ARCH-005-FINAL, dated August 2005, both incorporated by reference herein. Media servers, such as those manufactured by IP Unity, Milpitas, Calif., may be utilized as the media server 500 described here.

What is claimed is:

1. A method for determining the status of a target subscriber in a telecommunications network managed in part by a switch, comprising:
initiating a request for interception of a call to which the target subscriber is a party;
requesting the status of the target subscriber;
querying the status of the target subscriber; and
returning status information.

2. A method as set forth in claim 1, where the step of querying the status of the target subscriber comprises querying the status of a target subscriber in a remote network or managed by a remote switch.

3. A method as set forth in claim 1, further comprising the step of verifying that the request is authorized.

4. A method as set forth in claim 1, further comprising intercepting the call.

5. A method for enabling a monitoring agency to intercept call content of a target subscriber and one or more other parties participating in a call over a telecommunications network managed in part by a switch, comprising:
obtaining media information for the target subscriber and the other parties to the call, the media information comprising information identifying the media streams of the target subscriber and the parties to the call;
creating conference ports on a conference bridge for the target subscriber and the parties to the call;
re-routing the subscriber media streams to the ports of the conference bridge; and
providing the media streams of the target subscriber and the parties to the call to the monitoring agency.

6. A method as set forth in claim 5, where the step of providing the media streams of the target subscriber and the parties to the call to the monitoring agency comprises creating a port on the conference bridge for the monitoring agency.

7. A method as set forth in claim 5, where
the step of obtaining media information for the target subscriber and the parties to the call comprises obtaining the media information of one or more subscribers in a remote network or managed by a remote switch; and
the step of re-routing the subscriber media streams to the ports of the conference bridge comprises re-routing one or more media streams in a remote network or managed by a remote switch.

8. A method as set forth in claim 5, where the step of creating ports on the conference bridge comprises creating ports on a media server.

9. A method as set forth in claim 5, further comprising the preliminary step of determining the status of the target subscriber.

10. A method for enabling a monitoring agency to intercept call content of a target subscriber and one or more other parties participating in a call over a telecommunications network, the network managed in part by a switch, comprising:
initiating a request for interception of a call to which the target subscriber is a party;
requesting the status of the target subscriber;
querying the status of the target subscriber; and
returning status information;
in response to status information indicating that a call is in progress, obtaining media information for the target subscriber and the other parties to the call, the media information comprising information identifying the media streams of the target subscriber and the parties to the call;
creating conference ports on the media server for the target subscriber, the parties to the call, and the monitoring agency; and
re-routing the subscriber media streams of the target subscriber and the parties to the call to the ports of the media server.
